(19) United States
(12) Patent Application Publication
(10) Pub. No.: US 2011/0072596 A1
(43) Pub. Date: Mar. 31, 2011

(54) EXTENDABLE RAMP FOR STORAGE IN A TAILGATE OR FLAT BED

(76) Inventor: Mark Kenny, Jensen Beach, FL (US)

(21) Appl. No.: 12/921,399

(22) PCT Filed: Mar. 9, 2009
(86) PCT No.: PCT/US09/01489

§ 371 Date: Dec. 3, 2010

Related U.S. Application Data
(60) Provisional application No. 61/064,490, filed on Mar. 7, 2008.

(51) Int. Cl. B60P 1/43; E01D 1/00; B62D 25/00

(52) U.S. Cl. 14/69.5; 414/537; 296/61

(57) ABSTRACT

An extendable ramp system extending a ramp from a storage position on a vehicle tailgate or flatbed is provided. A collection box is shown having a collection box channel with a sliding member slidingly engaged and moving within the collection box channel and coupling an end of the ramp to the collection box, the sliding member being coupled to the end of the ramp closest to the collection box when the ramp is extended. An at least two folding structural members are provided having an at least one coupling member coupling the at least two folding structural members and the at least two folding structural members coupling to the at least one sliding member. An at least one horizontal structural member is coupled to the at least two folding structural members and being oriented parallel and horizontal relative to the collection box. An at least two folding support members are provided along with an extension member coupled to the at least two folding support members. A control element within the at least two folding support members or the extension member is provided, the control element slidingly engaging and coupling the at least two folding support members or the at extension member. An at least two support hinge members couple the at least two folding support members, where the at least two folding support members extend, unfold, and pivot on the at least two support hinge members and straighten and the extension member extends on the at least one control element to extend the ramp.

### CROSS REFERENCE TO RELATED APPLICATIONS

This application claims priority to U.S. provisional patent application 61/064,490, filed Mar. 7, 2008, which is incorporated herein by reference. It is also noted that Mar. 7, 2009 is a Saturday in the District of Columbia pursuant to §119(e)(3), the claim for priority is made the next business day Mar. 9, 2009.

### BACKGROUND OF THE INVENTION

1. Field of the Invention

The invention relates to an extendable ramp that is designed to collapse and store in a small enclosure or on a tailgate or flatbed.

2. Background of the Invention

A widely known issue within several industries and hobbies, such as the lawn care industry, is the lack of an efficient and portable extendable gate with sufficient rigidity to carry loads like mowers, edgers, small earth movers, ATV, pressure washers, motorcycles, snowmobiles, and similar equipment.

Several attempts at solutions have been provided. Ramps can be carried within the cargo area of a vehicle to be deployed when the vehicle comes to a stop. These ramps take up valuable cargo space and must be secured along with the cargo in the cargo area with restraints. This takes valuable time to deploy and then stow the ramps. It is not compact nor is it convenient and easy to extend or assemble quickly.

Other solutions have replaced the tailgate with a ramp that is substantially taller than the tailgate when in a secured position. These devices are difficult to install, bulky and require removal of a component of the vehicle—namely the original tailgate. Similarly, the height of the ramps typically extends well above the cab height of the vehicle, resulting in a hazard for low underpasses and telephone and other types of power and communications lines. Additionally, the fixed angle and size of the gate limits the gate and its deployment and functionality.

Still other solutions involve folding ramps that are stowed in the cargo bay or pull out from the cargo bay or fold to become cargo bay extenders. None of these solutions can provide for a collapsible, compact, portable, easy to extend and use solution that is versatile in its placement and extension for use.

To date, no simple, safe/non-slip, cost-effective solution has been provided that can be retroactively mounted to a tailgate on a typical heavy duty pick-up truck or flat bed. The vast majority of existing portable and/or retrofit solutions are also insecure, in that they have a higher potential to slip off of their mounting on the truck or platform.

Thus, there exists a need for a safe, inexpensive, robust, easy to operate, durable, and retrofittable extendable ramp that can be securely stowed in a small space like a tailgate or on a flat bed.

### SUMMARY OF THE INVENTION

An object of the invention is to provide a portable, easily storable ramp system that is expandable, efficient to deploy, and easy to use.

An object of the invention is to provide a storable, easily deployed ramp with sufficient strength and rigidity to offload lawn equipment and similar loads.

The invention includes an article of manufacture, an apparatus, a method for making the article, and a method for using the article.

The apparatus includes an expandable ramp system having a collection box having slots therein with an at least one sliding member contained within the collection box and coupled to and contained by the slots therein. The system include an at least two folding structural member having an at least one coupling member coupling the at least two folding structural members and coupling to the at least one sliding member. An at least one horizontal structural member is provided and coupled to the at least two folding structural members and oriented in a parallel and horizontal relative to the collection box and extending to form said expandable ramp.

A further embodiment of the system of the invention includes a collection box having slots therein coupled to a portion of a pickup truck bed with an at least one sliding member contained within the collection box and coupled to and contained by the slots therein. An at least two folding structural members are provided and coupled to the sliding member and have an at least one coupling member coupling the at least two folding structural members to one another. An at least one horizontal structural member is coupled to the at least two folding structural members and the at least one horizontal structural member is oriented in a parallel and horizontal manner relative to the collection box and extending to form said expandable ramp. Where the expandable ramp system expands from a closed state from the portion of the pickup truck bed such that the extension of the at least two folding structural members expands rotating the at least two structural members about the at least one coupling member and aligning the at least one horizontal structural member as the ramp is extended.

A still further embodiment of an extendable ramp system extending a ramp from a storage position on a vehicle tailgate or flatbed is also provided. The system including a collection box having a collection box channel with a sliding member slidingly engaged and moving within the collection box channel and coupling an end of the ramp to the collection box, the sliding member being coupled to the end of the ramp closest to the collection box when the ramp is extended. An at least two folding structural members are provided, having an at least one coupling member coupling the at least two folding structural members and the at least two folding structural members coupling to the at least one sliding member. An at least one horizontal structural member is coupled to the at least two folding structural members and being oriented parallel and horizontal relative to the collection box. An at least two folding support members are provided along with an at least one extension member coupled to the at least two folding support members. An at least one control element is likewise provided within the at least two folding support members or the at least one extension member, the at least one control element slidingly engaging and coupling the at least two folding support members or the at least one extension member. An at least two support hinge members are also provided coupling the at least two folding support members, wherein the at least two folding support members extend, unfold, and pivot on the at least two support hinge members and straighten and the at least one extension member extends on the at least one control element to extend the ramp.

The at least two support hinge members can be fixed in position relative to the at least two folding members. The at least two support hinge members can be slideable relative to the at least two folding members. The system can further include at least two safety pins, the safety pins being slipped into the at least two hinge members to prevent them from accidently folding or pivoting. The system can also include a drop plate extending from the end of the ramp when fully extended.

The system can also have an at least one control element that is an at least one pin, the at least one pin slidingly engaged in an at least one control channel in the at least one extension member and couple the at least one extension member and the at least two folding members, allowing the at least one extension member to be extended. The at least two folding support members can be formed from channel stock and have an end cut at complimentary angles so as to fold and stack in a collapsed state.

The system can also have a curved portion of the collection box channel at an end of the collection box that is situated on an end of the tailgate furthest from the vehicle. A locking slot can be provided, the locking slot engaging a locking pin in the ramp and locking the system when in the storage position.

An at least one collection box linkage can be coupled to the sliding member and fixed to the at least one collection linkage body portion, wherein the at least one control box linkage allows the ramp to extend from the storage position and then lower the end of the ramp nearest the collection box to be nearly flush with the tailgate. The collection box linkage can further comprise a linkage channel cut in the linkage body portion and a guide pin couples the top of the ramp closest to the collection box to the control linkage and the guide pin freely slides and rotates within the linkage channel.

A still further embodiment of the system provides an extendable ramp system extending a ramp from a storage position on a vehicle tailgate or flatbed, the system having a collection box having a collection box channel with a sliding member slidingly engaged and moving within the collection box channel and coupling an end of the ramp to the collection box, the sliding member being coupled to the end of the ramp closest to the collection box when the ramp is extended and an at least two overlap members coupled with an at least one hinge member such that as the ramp is extended, each of the at least two overlap members extends over and beyond the previous, each of the at least two overlap members being self locking and interlocking with the previous overlap member into position as the ramp is extended from the storage position. An at least one extension member is provided and coupled to the at least two folding support members with an at least one control element within the at least two folding support members or the at least one extension member, the at least one control element slidingly engaging and coupling the at least two folding support members or the at least one extension member. An at least two support hinge members are provided and couple the at least two folding support members, wherein the at least two folding support members extend, unfold, and pivot on the at least two support hinge members and straighten and the at least one extension member extends on the at least one control element to extend the ramp.

The method of the invention includes a method of extending a ramp from a storage position on a vehicle tailgate or flatbed to an extended position, comprising the method steps of:

lifting a locking pin from a locking slot, pulling the ramp from a collection box on the tailgate;

sliding a collection box linkage and sliding member down the collection in a collection box channel, moving the sliding pin up a curved section in the collection box channel, unfolding an at least two folding structural members that are coupled via connecting members throughout the length of the ramp and deploying in conjunction with at least two folding structural members an at least one tread, simultaneously extending an at least two folding support members, the at least two folding support members pivoting on an at least one support hinge member and straightening the at least two folding support members; and extending an at least one extension members from the at least two folding support members locking the at least two folded members and the at least one extension member in an extended position.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings of exemplary embodiments, where the same reference numerals refer to the same features.

FIG. 1 is a top view of an exemplary embodiment of the instant invention in its storage position.

FIG. 2 is a top view of the embodiment of FIG. 1 in its extended or deployed position.

FIG. 3 is a side view of the embodiment of FIG. 1 in its extended or deployed position.

FIG. 4 is a side view of the embodiment of an exemplary embodiment in a stored position.

FIG. 5 is a top view of a further embodiment of the instant invention.

FIG. 6 is a side view of the further embodiment of FIG. 5.

FIG. 7 is a top view of yet a further embodiment of the instant invention.

FIGS. 8 and 9 show a top view and a side view of a still further embodiment of the instant invention.

FIG. 10 shows a close up of the collection box rail and the collection box linkage in the extended position.

### DETAILED DESCRIPTION OF THE INVENTION

The invention relates to an extendable ramp that is designed to collapse and store in a small enclosure in or on a tailgate or flatbed. The structural components can include, for example, but are not limited to a series of bars, channels, any structural materials depending on application. Typically the bars intersect at similar distance and angles each intersection is a pivot or rotation point to extend or collapse, in a scissoring fashion, such that when in the closed position creates a condensed panel that is easily storable in a collection box. It also provides components allowing the ramp to vary its length in extension, to drop below the tailgate or flatbed when extended, and to lock and pin in position for safety.

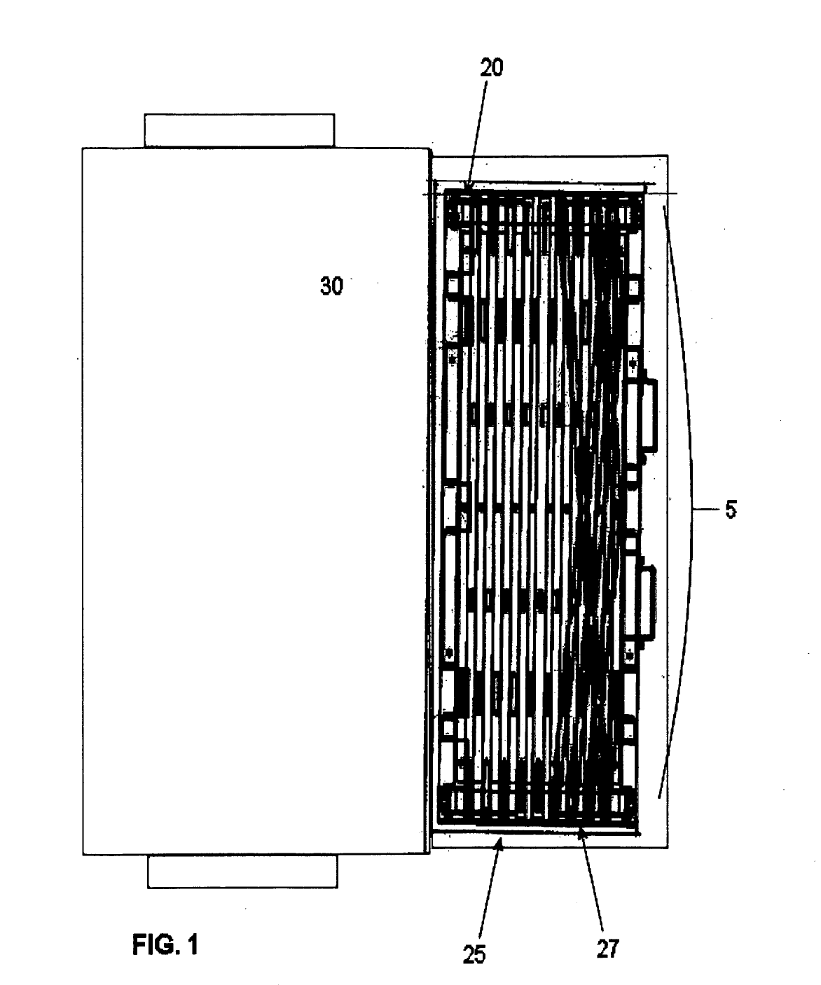

FIG. 1 is a top view of an exemplary embodiment of the instant invention in its storage position. A truck bed 30 is provided and a tailgate 25 is lowered and extends from the truck bed. A collection box 20 is shown containing the instant invention. The collection box can be fully enclosed or have an open top, as shown. In the embodiment shown, rails or sides or collection box body portion(s) 27 are provided on either side of the collapsed ramp and contain the collapsed ramp.

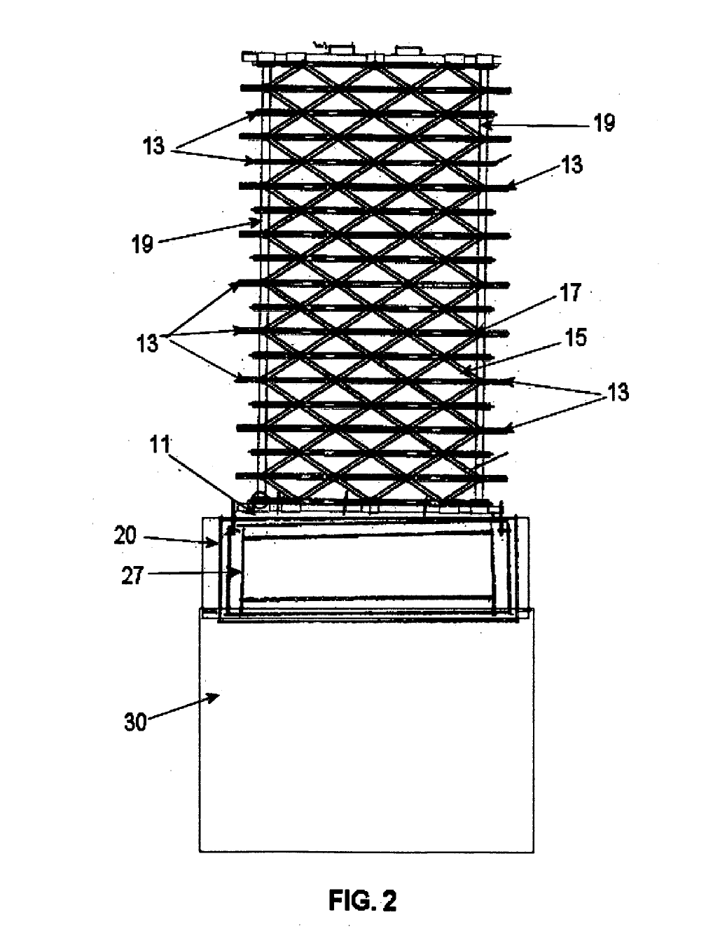

FIG. 2 is a top view of the embodiment of FIG. 1 in its extended or deployed position. In FIG. 2, the collapsible ramp is fully deployed. The collection box 20 is emptied. A sliding member 11 is provided with anchors in the sides or rails 27 of the collection box.

This sliding member 11 rests at the top of the extended ramp 5 when extended. A lattice-like extendable ramp 5 is provided. It is comprised in part, but is certainly not limited to folding structural members 15 that are coupled together via pivot or connecting members 17. In addition structural members or treads 13 are interspaced in a horizontal and parallel fashion to the collection box 20 and coupled to the folding structural members 15 via the pivot or connecting members 17 throughout the length of the ramp 5. In addition, the exemplary embodiment shown, reinforcement members 19 are provided to disperse the loads that concentrate at the pivot members 17, thereby adding to the strength of the ramp 5. When expanded or extended the ramp 5, including but not limited to folding structural members 15, connecting members 17, reinforcement members 19 and structural members 15 will create a larger surface of crisscrossing bars similar to a baby gate or expansion steel or old fashion coat rack.

In an exemplary embodiment the treads or structural members 13 can include slots that contain holes, the pivot points to move within the structural members. This allows the treads or structural members 13 to remain centered and aligned throughout the process of extending and collapsing the ramp 5. In other exemplary embodiments, these slots exist in every other tread or structural members 13. This reduces manufacturing costs while providing the same flexibility to allow the structural members 13 to self-center.

Each pivot or connecting member 17 is machined to a high tolerance to minimize flexure and other uncontrolled movements. In creating a higher tolerance fit, several manufacturing techniques can be utilized to minimize deviations, including but not limited to computer aided machining, laser cutting, hydropneumatic cutting, or similar technologies. Additionally, though not shown in the exemplary embodiment of FIGS. 1-2, additional rails, structural members or similar elements may be utilized to increase rigidity and strength in the ramp 5. For instance, collapsible or telescoping members may be included in additional embodiments that extend at perpendicular or near perpendicular angles relative to the collection box. Additional structural members can also be provided that extend under the existing folding structural members.

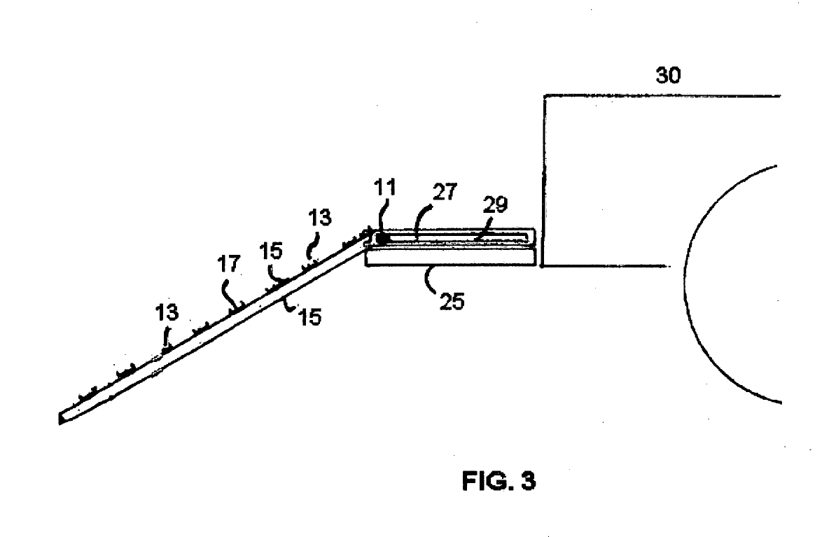

FIG. 3 is a side view of an exemplary embodiment of the invention in its extended or deployed position. The tailgate 25 is down and extends from the bed 30 with the ramp 5 being deployed therefrom. The sliding member 11 is more clearly shown engaged within slots or collection box channel 29 within the rails or body portion 27 of the collection box 20. The sliding member 11 slides and locks in a location furthest out along the collection box 20 relative to the bed 30 or tailgate 25. Folding structural members 15 coupled via the pivot or connecting members 17 throughout the length of the ramp 5 are shown in conjunction with structural members 13 running in a horizontal and parallel fashion relative to the collection box 20.

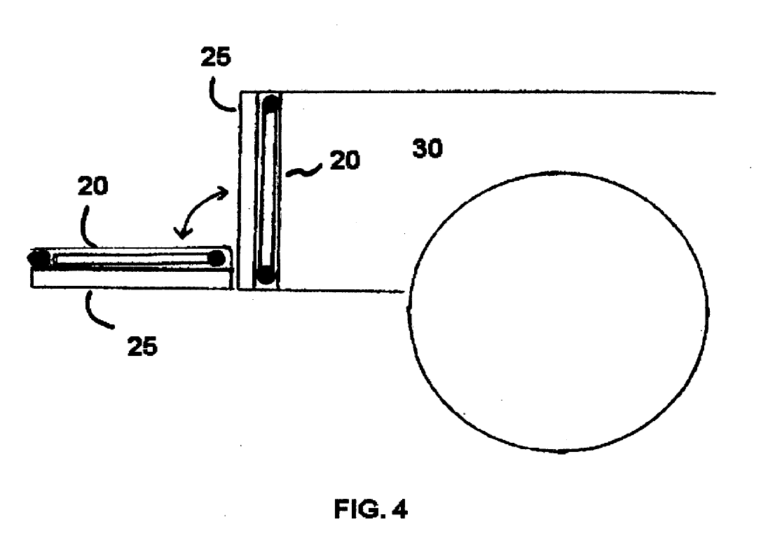

FIG. 4 is a side view of the embodiment of an exemplary embodiment in a stored position. In the exemplary embodiment shown the tailgate 20 is moved from an open position to a closed position with the ramp 5 stored in the collection box 20. This storage position is compact enough to fit in and be deployed from a typical pickup truck. A non-limiting example of the instant invention in the closed position collapses to 20 inches in width and 48 inches in length. In the extended or deployed position, the ramp is expanded to be 44 inches in width and 72 inches in length. The ramp can a retrofit kit to be deployed on existing transports or it can be incorporated into OEM equipment such as tail gate to be concealed in closed positions. The arrow shows the movement of the tailgate into a closed position with the ramp in a stored and locked position for transport on the vehicle as shown.

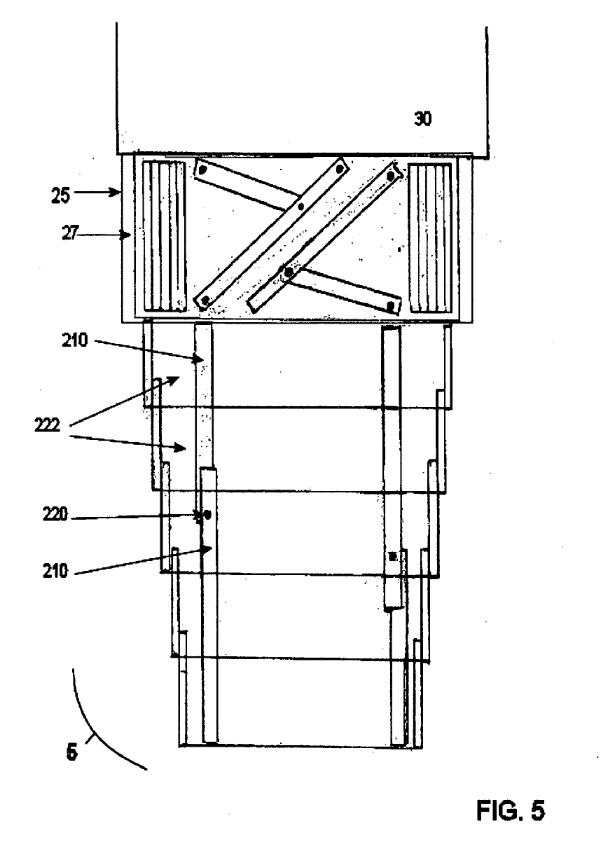

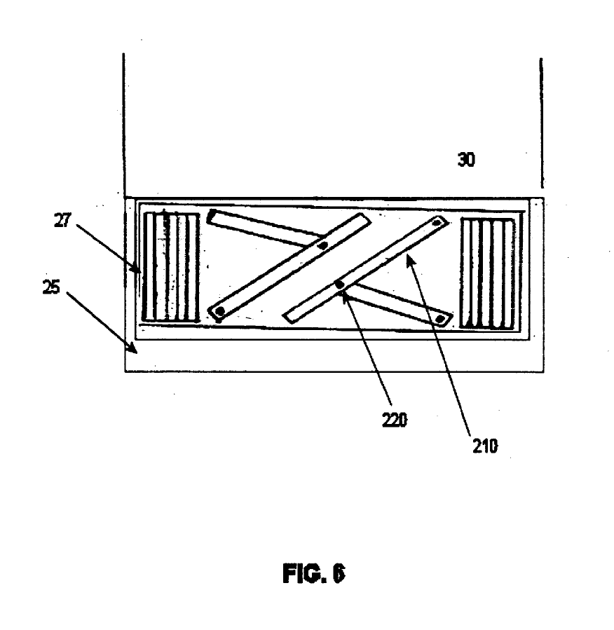

FIGS. 5 and 6 show a further embodiment of the invention. In the top view of FIG. 5 a further embodiment of the truck bed 30 and a tailgate 25 are shown and the tailgate 25 is lowered and extends from the truck bed 30. A collection box 20 is shown containing the further embodiment of the instant invention. As noted above, the collection box can be fully enclosed or have an open top, as shown. Additionally, the embodiment may use rails 27 as previously provided on either side of the collapsed ramp and contain the collapsed ramp or use similar mechanisms to facilitate easy storage and extension of the invention.

In the figure, overlap members 210 are shown. These overlap members 210 are coupled with a hinge member 220 so that as the ramp is extended, each member extends over and beyond the previous, as shown in the figure. Each overlap member 210 that is coupled by a hinge member 220 is self locking and interlocks with the previous overlap member 210 into position as the ramp is extended from the collection box 20. This provides a tapered ramp 200 upon full extension.

Atop the overlap members, a lattice like structure, as shown in the embodiments of FIGS. 1-4, can be spread or, as shown in FIGS. 5-7, overlapping tread plates 222. As the ramp unfolds and extends the plates slip over one another and extend to cover the tapered ramp 200.

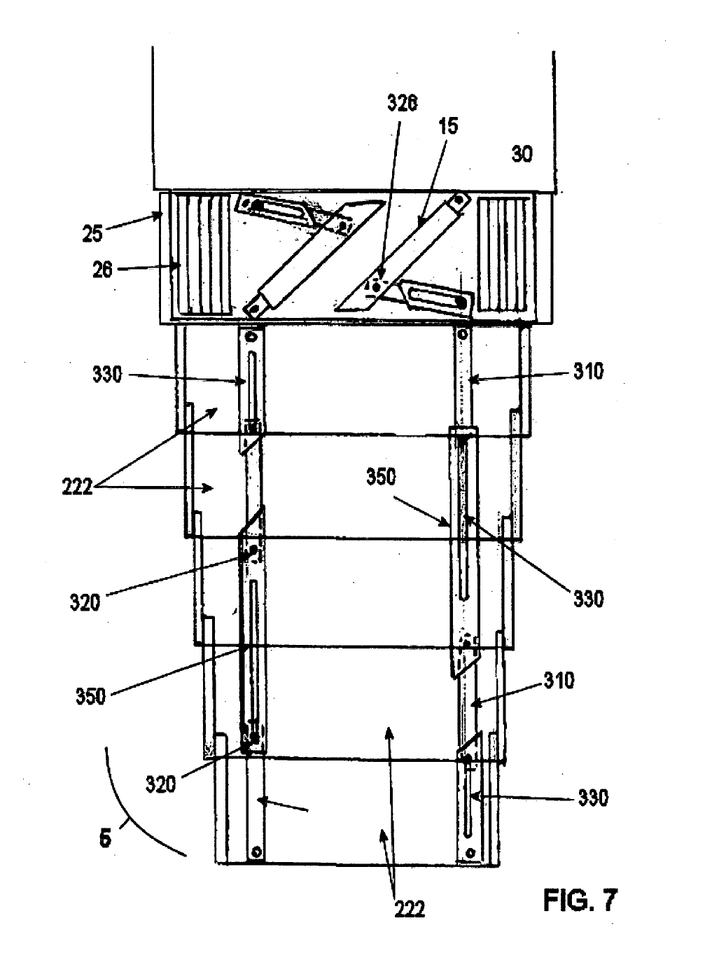

FIG. 7 is a top view of yet a further embodiment of the instant invention. In this embodiment, the extendable ramp 5 is comprised of elements that unfold and telescope within one another. As seen in the figure, the tailgate 25 is down and extends from the bed 30 with the ramp 5 being deployed therefrom. Folding structural members 15 can continue to be coupled via the pivot or connecting members 17 throughout the length of the ramp 5 and in conjunction with structural members 13 running in a horizontal and parallel fashion relative to the tailgate 25 as shown in the embodiment of FIG. 1 or overlapping tread plates 222 are can be used as shown. In addition, folding support members or outer support tubes 300 are provided. These folding support members 300 can be hollow or open on one side, for instance a channel stock material, and, in a folded state, contain extension members or inner tubes 310 within them. In the example shown, the folding support members 300 are channel stock and have an end cut at complimentary angles so as to fold and stack in a collapsed state.

Within the folding support members 300 or the extension members 310 are control elements 320. The control elements 320 can be pins for instance, the control elements 320 are fixed in the folding support members 300 and in this instance slide in a control channel 330 in the extension members 310 allowing them to be elongated. The placement of the control elements 320 can be varied, placement being reversed so that the control channel 330 is in the folding members 300 and the control elements 320 are in the extension members 310, or variations thereon. Additionally, the control elements 320 can be varied without departing from the spirit of the invention. The control elements 320 provide the extension capability in conjunction with the extension members 310. As the extension members 310 complete the traverse, the tread plates 222 extend over one another and form the tapered ramp 200 as shown.

The exemplary embodiment shown allows for quick and easy extension of the ramp 5 from the tailgate 25 as the folded members 300 extend, unfold, and pivot on support hinge members 350 and straighten. The support hinge members 350 are fixed in this embodiment, but can be made slideable. After extending and locking the folded members 300 the extension members 310 are extended from the folded members 300 to extend the ramp 5 to its full length. In this instance, the control elements 320 slide along the control channels 330 and thereby allow the extension members 310 to reach full length. All along, the ends of the folded members 300 and extension members 310 are allowed to overlap to provide additional support at the connection point between these elements.

Additionally, at least one of the control elements support hinge members 350 is provided such that each side is hinged and as the ramp is closed the extension members 310 collapse into the folding members 300, when they are fully collapsed the folding members 310 that are cut with complementary angles, here shown as two 45 degree angles, deflect one another into rotation around the hinge point/hinge in the support hinge member 350 and thereby fold the folding members 300 when collapsing the ramp 5. Similarly, when extending the ramp 5, the folding members rotate about the respective control elements 320 that are hinged/hinged support members 350 and once the complimentary angles meet the extension members 310 extend and are moved along with the respective control members 320 in the respective control channel 330.

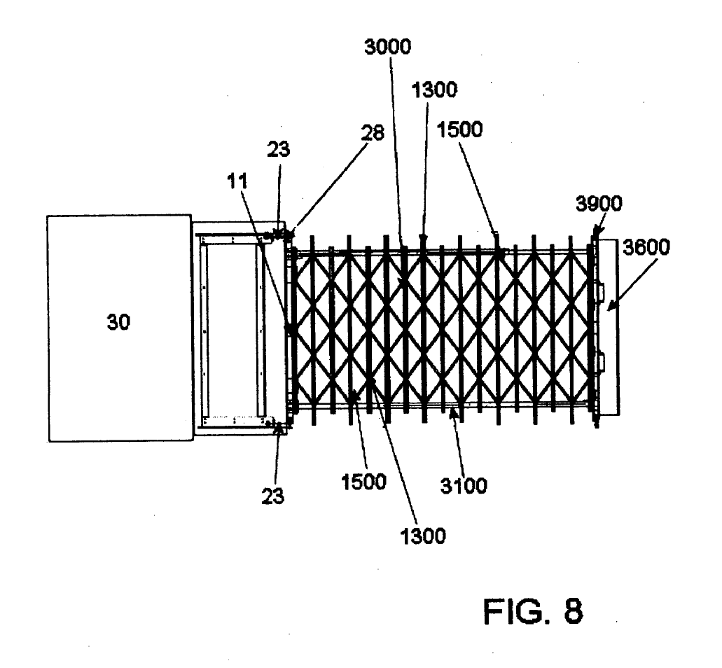

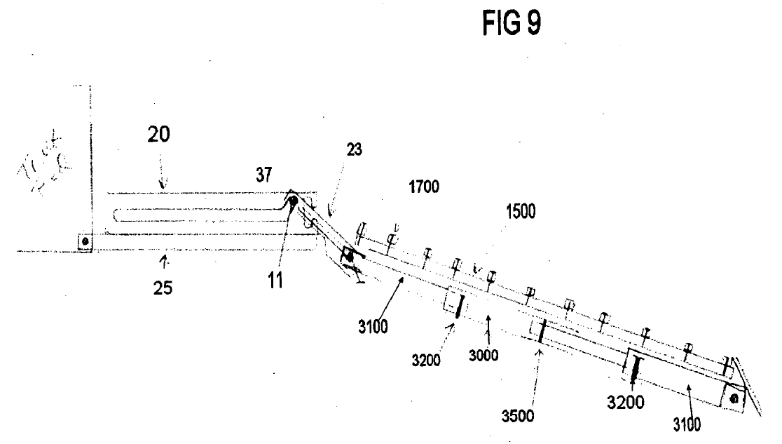

FIGS. 8 and 9 show a further embodiment of the invention. The embodiment shown is similar to FIGS. 6 and 7 with the lattice structure covering the ramp. In the top view of FIG. 8 a further embodiment of the truck bed 30 and a tailgate 25 are shown and the tailgate 25 is lowered and extends from the truck bed 30. The collection box 20 is shown containing the further embodiment of the instant invention.

As noted above, the collection box 20 can be fully enclosed or have an open top, as shown. Additionally, the embodiment may use rails 27 as previously provided on either side of the collapsed ramp and contain the collapsed ramp or use similar mechanisms to facilitate easy storage and extension of the invention.

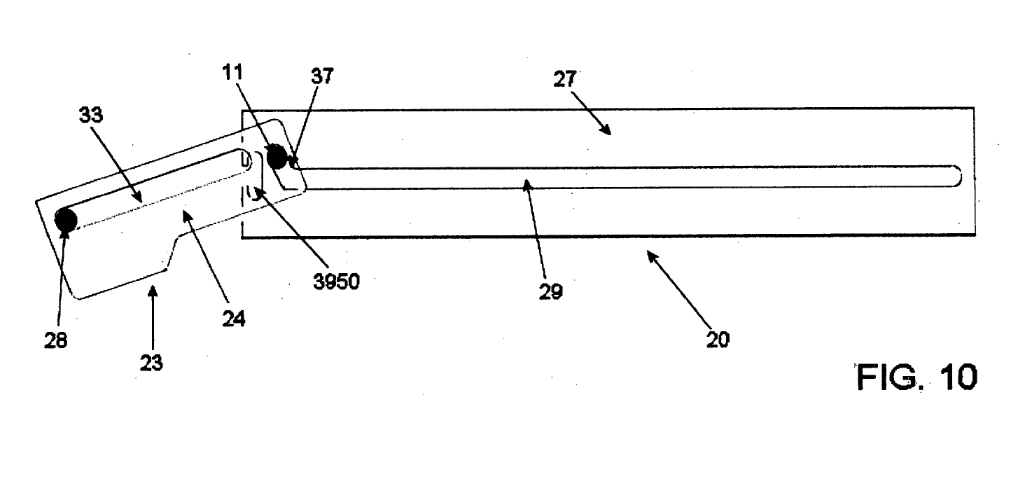

A collection box linkage 23 is provided. The collection box linkage 23 connects the collection box 20 to the ramp 5 in the exemplary embodiment shown in FIGS. 8 and 9 and can be utilized in any of the aforementioned embodiments. The collection box linkage 23 includes the sliding member 11 at one end and body portion 24; this is the sliding member that as previously noted slides within the collection box channel 29. In addition, the body portion 24 of the collection box linkage 23 has a linkage channel 33. A guide pin 28 coupled to the ramp 5 slides inside the collection box linkage 23 within the linkage channel 33. The collection box channel 29 is cut such that when the ramp 5 is extended the collection box linkage 23 allows the ramp 5 to drop below the level of the tailgate or flatbed 25 of the vehicle. This is accomplished by a curved or “dog leg” section 37 of the collection box channel 33, as more clearly shown in FIG. 10. When extending the ramp, the collection box linkage 23 is drawn out of the collection box 20 and the sliding member 11 slides along the collection box channel 29 and up the dog leg portion 37 and comes to a stop at this point.

When moving the ramp 5 from an extended to a closed or stored position the ramp 5 moves the guide pin 28 along the linkage channel 33 the collection box linkage 23 is then moved through along the collection box channel 33 to the opposing end in the collection box channel 33 with the remainder of the ramp 5 collapsing and storing behind collection box linkage 23. The guide pin 28 slides down the linkage channel 33 to an end furthest from the collection box 20 when fully retracted. When fully extended along the collection box channel 33, the collection box linkage 23 allows the ramp 5 to drop at an angle so that the top of the ramp becomes nearly flush with the tailgate 25, allowing for easier loading and unloading of vehicles and the like with the instant invention.

FIGS. 8 and 9 depict an embodiment of the instant invention utilizing the aforementioned collection box linkage 23 and the lattice like ramp. In this embodiment, the extendable ramp 5 is comprised of elements that unfold and telescope within one another, similar to the embodiment of FIG. 7. A locking pin 3900 is provided and engages the collection box 20 at locking slot 3950 when the ramp is closed. The extension of the ramp begins by lifting the locking pin 3900 from the locking slot 3950 and pulling the ramp 5 from the collection box 20 on the tailgate 25. The collection box linkage 23 and sliding member 11 move down the collection box channel 29. The sliding pin moves up the curved section 37 in the collection box channel 29 and stops. Similar folding structural members 1500 are coupled via the pivot or connecting members 1700 throughout the length of the ramp 5 and in conjunction with structural members or treads 1300 running in a horizontal and parallel fashion relative to the tailgate 25 these members begin to unfold.

Folding support members 3000 contain extension members or inner tubes 3100 within them. In the example shown, the folding support members 3000 are channel stock and have an end cut at complimentary angles so as to fold and stack in a collapsed state. Within the folding support members 3000 or the extension members 3100 are control elements 3200. The control elements 3200 can be, but are not limited, to pins for instance in a control channel 3300 in the extension members 3100 allowing them to be elongated. Additionally, the control elements 3200 and the spacing and location can be varied without departing from the spirit of the invention. The folded members 3000 extend, unfold, and pivot on support hinge members 3500 and straighten. The support hinge members 3500 are again fixed in this embodiment, but can be made slideable. After extending and locking the folded members 3000 the extension members 3100 are extended from the folded members 3000 to extend the ramp 5 to its full length. Safety pins 3800 can then be slipped into the folded members 3000 to prevent hinged members 3500 from accidently closing. An additional component, drop plate 3600 extends from the end of ramp 5 when fully extended to further aid in the smooth loading and unloading of vehicles and the like via the ramp.

When closing the ramp 5, in the exemplary embodiment the safety pins 3800 are removed and drop plate 3600 is flipped back up onto the ramp 5. The end of the ramp 5 where the drop plate 3600 is mounted is lifted. The ramp 5 is moved toward the tailgate causing the control members 3200 to slide in the respective control channels 3300 until they are fully collapsed into the support members 3000, the support members 3000 meeting at the complimentary angles, as described in relation to FIG. 7. The complimentary angle redirects the pushing force in the direction of rotation about the hinged member 3500 and begins to collapse the support members 3000. Throughout this motion the folding structural members 1500 begin to pivot or scissor from an open state to a closed state around pivot members 1700. Structural members or treads 1300 also begin to stack. Once the structural members 1500 and Support members 3000 are fully collapsed the ramp 5 in its closed or storage position is moved on the sliding member 1100 inside the collection box 20 until the locking pin 3900 is engaged in the locking slot 3950.

FIG. 10 shows a close up of the collection box rail and the collection box linkage in the extended position. The collection box 20 is shown in greater detail. The collection box 20 has a body portion 27 with a collection box channel 29 cut therein. A curved or “dog leg” portion 37 is provided at an end of the collection box 20 that is to be situated on an end of the tailgate 25 furthest from the vehicle 30. A locking slot 3950 is provided at the same end. A collection box linkage 24 is shown coupled to a sliding member 11 fixed to the collection linkage body portion 24. The sliding member 11 can for instance be, but is certainly not limited to, a pin or solid rod. The sliding member 11 freely slides and rotates within the collection box channel 29. Within the collection box linkage 23 a linkage channel 33 is cut in the linkage body portion 24. A pin 28 couples the top of the ramp 5 to the control linkage and the guide pin 28 freely slides and rotates within the linkage channel. The control box linkage 33 allows the ramp 5 to extend out and then lowers the end of the ramp to be nearly flush with the tailgate 25. The control box linkage 33 can be utilized in conjunction with any of the aforementioned embodiments to provide this positioning of the ramp 5 when extended.

The embodiments and examples discussed herein are non-limiting examples. The invention is described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

1. An expandable ramp system comprising:
a collection box having slots therein;
an at least one sliding member contained within the collection box and coupled to and contained by the slots therein;
an at least two folding structural member having an at least one coupling member coupling the at least two folding structural members and coupling to the at least one sliding member; and
an at least one horizontal structural member coupled to the at least two folding structural members and being oriented in a parallel and horizontal relative to the collection box and extending to form said expandable ramp.

2. An expandable ramp system contained in at least a portion of a pickup truck bed, comprising:
a collection box having slots therein coupled to said portion of a pickup truck bed;
an at least one sliding member contained within the collection box and coupled to and contained by the slots therein;
an at least two folding structural member coupled to the sliding member and having an at least one coupling member coupling the at least two folding structural members to one another; and
an at least one horizontal structural member coupled to the at least two folding structural members and the at least one horizontal structural member being oriented in a parallel and horizontal manner relative to the collection box and extending to form said expandable ramp, wherein the expandable ramp system expands from a closed state from the portion of the pickup truck bed such that the extension of the at least two folding structural members expands rotating the at least two structural members about the at least one coupling member and aligning the at least one horizontal structural member as the ramp is extended.

3. (canceled)

4. (canceled)

5. An extendable ramp system extending a ramp from a storage position on a vehicle tailgate or flatbed, the system comprising:
a collection box having a collection box channel;
a sliding member slidingly engaged and moving within the collection box channel and coupling an end of the ramp to the collection box, the sliding member being coupled to the end of the ramp closest to the collection box when the ramp is extended;
an at least two folding structural members having an at least one coupling member coupling the at least two folding structural members and the at least two folding structural members coupling to the at least one sliding member;
an at least one horizontal structural member coupled to the at least two folding structural members and being oriented parallel and horizontal relative to the collection box;
an at least two folding support members;
an at least one extension member coupled to the at least two folding support members;
an at least one control element within the at least two folding support members or the at least one extension member, the at least one control element slidingly engaging and coupling the at least two folding support members or the at least one extension member; and
at least two support hinge members coupling the at least two folding support members, wherein the at least two folding support members extend, unfold, and pivot on the at least two support hinge members and straighten and the at least one extension member extends on the at least one control element to extend the ramp.

6. The system of claim 5, wherein the at least two support hinge members are fixed in position relative to the at least two folding members.

7. The system of claim 5, wherein the at least two support hinge members are slideable relative to the at least two folding members.

8. The system of claim 5, further comprising at least two safety pins, the safety pins being slipped into the at least two hinge members to prevent them from accidently folding or pivoting.

9. The system of claim 5, further comprising a drop plate extending from the end of the ramp when fully extended.

10. The system of claim 5, wherein the at least one control element is an at least one pin, the at least one pin slidingly engaged in an at least one control channel in the at least one extension member and couple the at least one extension member and the at least two folding members, allowing the at least one extension member to be extended.

11. The system of claim 5, wherein the at least two folding support members are formed from channel stock and have an end cut at complimentary angles so as to fold and stack in a collapsed state.

12. The system of claim 5, further comprising a curved portion of the collection box channel at an end of the collection box that is situated on an end of the tailgate furthest from the vehicle.

13. The system of claim 5, further comprising a locking slot, the locking slot engaging a locking pin in the ramp and locking the system when in the storage position.

14. The system of claim 5, further comprising an at least one collection box linkage coupled to the sliding member and fixed to the at least one collection linkage body portion, wherein the at least one control box linkage allows the ramp to extend from the storage position and then lower the end of the ramp nearest the collection box to be nearly flush with the tailgate.

15. The system of claim 14, wherein the collection box linkage further comprises a linkage channel cut in the linkage body portion and a guide pin couples the top of the ramp closest to the collection box to the control linkage and the guide pin freely slides and rotates within the linkage channel.

16. An extendable ramp system extending a ramp from a storage position on a vehicle tailgate or flatbed, the system comprising:
a collection box having a collection box channel;
a sliding member slidingly engaged and moving within the collection box channel and coupling an end of the ramp to the collection box, the sliding member being coupled to the end of the ramp closest to the collection box when the ramp is extended;
an at least two overlap members coupled with an at least one hinge member such that as the ramp is extended, each of the at least two overlap members extends over and beyond the previous, each of the at least two overlap members being self locking and interlocking with the previous overlap member into position as the ramp is extended from the storage position;
an at least one extension member coupled to the at least two folding support members;
an at least one control element within the at least two folding support members or the at least one extension member, the at least one control element slidingly engaging and coupling the at least two folding support members or the at least one extension member; and
at least two support hinge members coupling the at least two folding support members, wherein the at least two folding support members extend, unfold, and pivot on the at least two support hinge members and straighten and the at least one extension member extends on the at least one control element to extend the ramp.

17. A method of extending a ramp from a storage position on a vehicle tailgate or flatbed to an extended position, comprising the method steps of:
lifting a locking pin from a locking slot;
pulling the ramp from a collection box on the tailgate;
sliding a collection box linkage and sliding member down the collection in a collection box channel;
moving the sliding pin up a curved section in the collection box channel;
unfolding an at least two folding structural members that are coupled via connecting members throughout the length of the ramp and deploying in conjunction with at least two folding structural members an at least one tread;
simultaneously extending an at least two folding support members, the at least two folding support members pivoting on an at least one support hinge member and straightening the at least two folding support members; and
extending an at least one extension members from the at least two folding support members locking the at least two folded members and the at least one extension member in an extended position.

18. An expandable ramp system contained in at least a portion of a pickup truck bed, comprising:
a collapsible ramp structure, having:
at least two collapsing scissoring members forming a support lattice;
at least two collapsible outer or rail members, the support lattice spanning between two collapsible outer or rail members, the outer or rail members bounding the at least two scissoring members in both the collapsed and uncollapesed state;
at least one tread or support member extending perpendicularly across the outer or rail members and likewise collapsing to stack on top of one another in a collapsed state;
a box or tailgate coupled to the portion of the pickup truck bed, wherein the ramp structure is coupled to the box or tailgate and collapses into the box or tailgate, the scissor members pivoting below the tread members and the rail members collapsing with the scissor members to fit within the confines of the box or tailgate.

19. The expandable ramps system of claim 3, further comprising a hinge mechanism attaching the ramps structure to the box or tailgate and at least one guide or slide members, the hinge mechanism allowing for the expandable ramps system to be extended fully from the box or tailgate and the at least one guide or slide member allowing for sliding of and stowage of the collapsed ramps structure in the tailgate or box.
